(19) United States
(12) Patent Application Publication
(10) Pub. No.: US 2005/0074591 A1
(43) Pub. Date: Apr. 7, 2005

(54) Transparent substrate with antiglare coating having abrasion-resistant properties

(76) Inventor: Georges Zagdoun, Colombes (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/501,330

(22) PCT Filed: Mar. 5, 2003
(86) PCT No.: PCT/FR03/00702

(30) Foreign Application Priority Data
Mar. 6, 2002 (FR) 02/02832

(51) Int. Cl. B32B 7/02

(52) U.S. Cl. 428/212

(57) ABSTRACT

Transparent, especially glass, substrate (10) having at least one functional element (20) on one face and an antireflection coating (11) on the opposite face, characterized in that the substrate includes an abrasion-resistant antiscratch coating, said coating being formed by the antireflection coating (11) made from a stack of thin dielectric layers having alternating high and low refractive indices.

The invention relates to transparent, most particularly glass, substrates which are provided with an antireflection coating with abrasion resistance properties. It also relates to their use as glazing or filters for display screens, for example plasma screens.

The function of an antireflection coating deposited on a transparent substrate is to reduce its light reflection, and therefore to increase its light transmission. A substrate thus coated therefore sees an increase in its transmitted light/reflected light ratio, thereby improving the visibility of objects placed behind it. When it is desired to achieve the maximum antireflection effect, it is then preferable to provide both faces of the substrate with this type of coating.

It can then be employed in many applications, for example for protecting a painting illuminated by a light placed behind the observer, or for constituting or forming part of a shop window so that what is in the window is more clearly distinguishable, even when the interior lighting is low compared with the exterior lighting.

The performance of an antireflection coating can be measured or evaluated according to various criteria. Coming first, of course, are optical criteria. For an antireflection coating to be considered “good”, it must be able to reduce the light reflection of a standard clear glass substrate down to a given value, for example 2%, or even 1% and less.

The multilayer coating is often used for glazing in buildings and automobiles. It comprises thin interferential layers deposited on the substrate, generally an alternation of high and low refractive index layers.

International patent application WO 01/37006 teaches a multilayer antireflection coating that meets the criterion of good optical quality and also has the advantage of maintaining this quality within a wide range of angles of incidence oblique to the vertical, possibly ranging from 50 to 700 of inclination. This type of coating is particularly appreciated for windshield-type glazing and shop counters.

Another antireflection coating is known, consisting of a plastic antireflection film which is used, however, for display screens of any type, and for example plasma screens. Such a film is generally combined with a transparent window serving as filter for the display screen.

A plasma screen comprises a plasma gas, trapped between two glass sheets, and phosphors placed on the internal face of the rear sheet of the screen. When the screen is operating, the interactions between the plasma gas particles and the phosphors cause the radiation of electromagnetic waves that lie within the near infrared between 800 and 1000 nm, the propagation of these electromagnetic waves, mainly through the front face of the screen, may be the cause of very troublesome interference, especially in the case of equipment placed nearby and controlled by infrared, for example using remote control means.

Moreover, like all electronic equipment, plasma screens possess addressing systems (drivers) which may generate radiation that is parasitic with regard to other devices, such as microcomputers, portable telephones, etc., with which they must not interfere.

To eliminate, or at the very least reduce, the propagation of such radiation, one solution consists in placing against the front face of the stream a window that is both transparent and metallized in order to provide electromagnetic shielding. Thus, this shielding may comprise one or more metal layers, especially silver layers, and/or one or more metal grids. This shielding may advantageously be provided by a stack of at least two metal layers made of silver which are either deposited directly on the glass substrate constituting the window and facing the screen or are deposited on an adhesive film bonded to the substrate facing the screen. Generally, this adhesive film has an antireflection function (with respect to light radiation coming from the screen) in order to improve the brightness of the screen by reducing the light reflection. It also plays a role in protecting the conducting silver layers from chemical corrosion.

The substrate of the window may be made of toughened glass or untoughened glass.

Provided on the external face of the substrate, that is to say on the opposite side from the screen and facing the observer, is also an adhesive film which is capable of retaining the glass fragments, should the toughened glass break and fragment, and which furthermore fulfills an antireflection function for the comfort of the observer. The film is placed last on the substrate, as it would not be able to withstand the various treatments that the substrate may undergo for the purpose of depositing functional elements, such as the stack of metal layers. However, it may happen that, despite all the precautions taken, the face that has to receive this film is scratched by the various substrate handling operations during the treatment steps or even by the treatments themselves, and this is prejudicial both to the quality of the surface and the strength of the substrate itself. The substrate will then be unable to be used and will be scrapped.

Furthermore, since the film is placed on the external face of the protective window intended to be combined with a display screen, the repeated actions of cleaning the protective screen will end up damaging this antireflection film. This impairs the antireflection properties and causes a haze to the detriment of vision, the film then having to be replaced.

Thus, the object of the invention is to provide a substrate, intended in particular for display screen filters, which has at least one functional element on one face and an antireflection coating on its opposite face, while being ensured that the substrate does not have defects of the scratch type on leaving its manufacturing process and that the antireflection coating is durable and abrasion resistant.

According to the invention, the substrate, especially a glass substrate, having at least one functional element of the metal element type on one face and an antireflection coating on the opposite face, is characterized in that the substrate includes an abrasion-resistant antiscratch coating, said coating being formed by the antireflection coating made from a stack of thin dielectric layers having alternating high and low refractive indices.

The invention also relates to a transparent, especially glass, substrate having an antireflection coating on at least one face, characterized in that the substrate includes an antiscratch coating having a resistance of at least 3H and with an abrasion resistance such that the haze of the substrate that may be caused remains less than 1.5%, said coating being formed by the antireflection coating made from a stack of thin dielectric layers of alternating high and low refractive indices.

According to one feature, the multilayer antireflection coating is deposited on the substrate before the functional element is deposited.

Thus, the substrate coated firstly with the stack of antireflection layers does fulfill its antireflection function as desired, and this allows the substrate to be treated in order to deposit functional elements on one of the faces without any risk of damaging the opposite face, since the latter has already been coated with an antireflection coating formed by the stack of antireflection layers.

According to another feature, the stack is based on Si₃N₄ or SnO₂ and SiO₂ layers. It has been found in fact that this type of combination of layers is particularly abrasion resistant and is so for relatively large areas, that is to say well in excess of 10 cm².

Preferably, the stack comprises:
a high-index first layer (c1) having a refractive index n₁ between 1.8 and 2.2 and a geometrical thickness e₁ between 5 and 50 nm;
a low-index second layer (c2) having a refractive index n₂ between 1.35 and 1.65 and a geometrical thickness e₂ between 5 and 50 nm;
a high-index third layer (c3) having a refractive index n₃ between 1.8 and 2.2 and a geometrical thickness e₃ between 70 and 120 nm; and
a low-index fourth layer (c4) having a refractive index n₄ between 1.35 and 1.65 and a geometrical thickness e₄ of at least 80 nm.

The inventors thus had the not obvious idea of using the antireflection multilayer stack as abrasion-resistant antiscratch coating for substrates that are already large in size, such as glazing or display screen filters, which hitherto used plastic films as antireflection coating and had no antiscratch properties.

Consequently, the invention also relates to glazing or a filter, characterized in that it is composed of the single substrate provided with a stack of antireflection layers on one of its faces and with the functional element, formed from a metallic element for the purpose of electromagnetic shielding, on its other face. The application is especially intended for the manufacture of filters for display screens, such as plasma screens.

The metallic element consists, for example, of at least one conducting metal layer, or rather of a stack of thin layers including at least two silver layers. Advantageously, the conducting metal layer is based on silver and forms part of a multilayer stack having the following sequence:
Si₃N₄/ZnO/Ag/Ti/Si₃N₄/ZnO/Ag/Ti/ZnO/Si₃N₄.

As a variant, the functional element may consist of a network of wires in the form of a grid, or else of a combination of a stack of silver-based thin layers and a network of wires in the form of a grid.

The functional element may be deposited directly on the substrate or deposited on a plastic film bonded to the substrate, or else it may be laminated between two plastic films, one of which is bonded to the substrate whereas the other is bonded to another substrate.

In the case of display screens, the functional element is preferably combined with an antireflection coating, which may either be an antireflection multi-layer stack or an adhesive antireflection film.

Finally, it will be preferred to use a substrate made of untoughened glass for the display screen application, since the substrate, equipped with one or more functional elements and with the stack of antireflection layers, may thus be manufactured with a large area and easily cut to the dimensions of display screen filters without any risk of the fully equipped substrate breaking.

Other advantages and features of the invention will become apparent on reading the description that follows, in conjunction with the appended drawings in which:

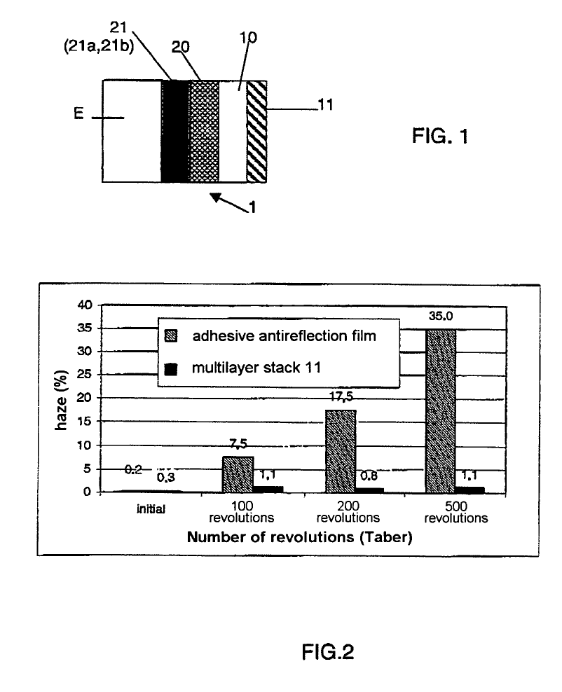

FIG. 1 is a schematic sectional drawing of a filter according to the invention combined with a plasma screen;

FIG. 2 illustrates a graph comparing various antireflection coatings;

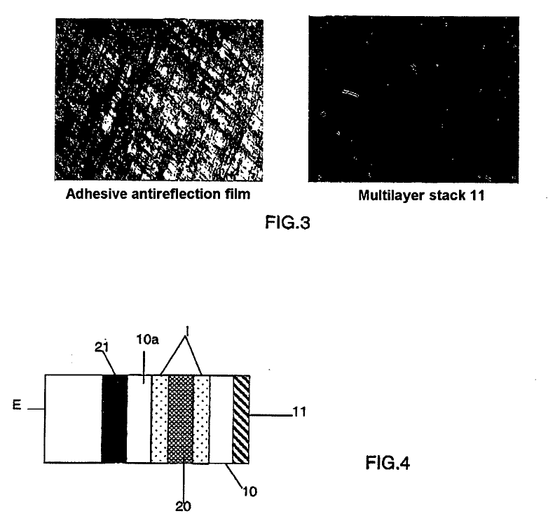

FIG. 3 shows two images of a coating, of the film type and of the multilayer stack type, respectively; and

FIG. 4 shows a sectional view of an alternative filter according to the invention, combined with a plasma screen.

It should firstly be pointed out that the various dimensions, especially thicknesses, of the elements of the invention in the drawings are not to scale so that they are easier to examine.

FIG. 1 illustrates a transparent window 1 intended to be joined to the front face of a plasma screen E. This window constitutes a filter providing electromagnetic shielding protection and antireflection protection.

The transparent window 1 is formed from a single substrate, such as a glass sheet 10, on which is deposited, on the one hand against the internal face, that facing the screen, a first functional element 20 formed by a stack of metal layers having electromagnetic shielding properties and a second functional element 21 formed by an internal antireflection coating covering the multilayer stack 20 and, on the other hand against the external face, on the opposite side from the screen and facing a possible observer, a multilayer stack 11 which constitutes not only an antireflection coating but also an abrasion-resistant antiscratch coating.

The substrate 10 is made of a clear soda-lime silicate glass of the PLANILUX type with a thickness of 3 to 6 mm, for example 4 mm. This product is sold by Saint-Gobain Glass.

To take an example, the stack of metal layers 20 is formed by at least two electrically conducting functional layers, of the Ag type. These metal layers are inserted into a stack of thin protective layers, a preferred sequence of which is as follows:
glass/Si₃N₄/ZnO/Ag/Ti/Si₃N₄/ZnO/Ag/Ti/ZnO/Si₃N₄.

The Ti layer constitutes a metal layer for protecting the silver, especially by preventing the silver from oxidizing.

A TiO₂ layer may be inserted between the Si₃N₄ and ZnO layers close to the glass so as to “wash” the color of the substrate in reflection.

All the layers of the stack are deposited by a known sputtering technique onto the internal face of the substrate, that intended to face the screen. The layers are in all cases deposited directly on the glass substrate and not on a plastic film, as is sometimes carried out in the prior art, since, as will be seen by the results of Example 3 later, a film supporting these metal layers generates more haze.

The first metal layer, of Ag, placed closest to the substrate has a thickness e₁ approximately equivalent to the thickness e₂ of the second metal layer, of Ag, so that the thickness ratio e₁/e₂ is between 0.8 and 1.1, and preferably between 0.9 and 1. Thus, the light transmission, greater than 67%, is very suitable. The total thickness e₁+e₂ of the metal layers is between 27 and 30 nm. To obtain good reflection of the infrared radiation toward the screen, that is to say that the radiation passes through the substrate as little as possible, it will be preferred to choose a total thickness of the metal layers between 28 and 29.5 nm, the transmission of the radiation thus not exceeding 13% for a wavelength of 800 nm.

The table below gives an example of the thickness values for the various thin layers of the stack, with total thicknesses e₁ plus e₂ equal to 14 nm.

| Glass | Thickness (nm) |
|---|---|
| Si₃N₄ | 20 |
| TiO₂ | 5 |
| ZnO | 10 |
| Ag | 14 |
| Ti | 1.5 |
| Si₃N₄ | 73 |
| ZnO | 10 |
| Ag | 14 |
| Ti | 1.5 |
| ZnO | 10 |
| Si₃N₄ | 22.5 |

Of course, other variations of metal elements for electromagnetic shielding are conceivable, such as metal grids or a combination of grids and layers. Thus, reference may be made to international patent application WO 01/81262. Furthermore, the functional element 20 providing electromagnetic shielding is deposited directly on the glass, but may as a variant be deposited on an adhesive plastic film bonded to the internal face of the window, or else may be laminated between two plastic inserts I adhesively bonded to two substrates, such as the substrate 10 and a glass substrate 10a facing the screen, the substrate 10 being provided with the internal coating 21 (FIG. 4).

According to a first embodiment, the internal antireflection coating 21 covering the multilayer stack 20 may be a standard plastic antireflection film 21a or a multilayer stack 21b of the stack 11 type.

The multilayer stack 21b of the 11 type makes it possible, compared with the film, which may be fragile, for the silver layers of the stack 20 to be very suitably protected from corrosion because they are covered by silica or silicon nitride.

However, the advantage of a film for the functional element 21, apart from all the glass splinters being retained by it should the window break, is that it may have an effect on the contrast of the screen. There are various types of film, these depending on their light transmission. Thus, it will be possible to use a film having a light transmission of 80% sold by Calsak or else one having a lower transmission, to improve the contrast of the screen, such as a film of 70% light transmission sold by Southwall (product name ARA2-70).

Finally, the antireflection multilayer stack 11 according to the invention is a stack of at least two layers based on Si₃N₄ or SnO₂ and SiO₂, which are particularly suitable because of their hardness property. These layers were all deposited conventionally by magnetically enhanced reactive sputtering in an oxidizing atmosphere using an Si target or a metal target to make the SiO₂ or metal oxide layers, using an Si or metal target in a nitriding atmosphere to make nitrides, and in a mixed, oxidizing/nitriding atmosphere to make the oxynitrides. The Si targets may contain another metal in a small amount, especially Zr or Al, in particular so as to make them more conducting.

A preferred antireflection stack is the following:
glass/SnO₂ (or Si₃N₄)/SiO₂/SnO₂ (or Si₃N₄)/SiO₂.

The table below gives the index nᵢ and the geometrical thickness eᵢ in nanometers of each of the layers, the layer c1 being that against the glass.

| | LAYER (c1) | LAYER (c2) | LAYER (c3) | LAYER (c4) |
|---|---|---|---|---|
| nᵢ | 2.0 | 1.46 | 2.0 | 1.46 |
| eᵢ | 15 nm | 30 nm | 70 nm | 90 nm |

The purpose of this example is to minimize as far as possible the value of the light reflection R_{L} of the glass (on the observer's side) at 60° incidence.

The table below gives results in light reflection on the observer's side and of optical haze of the filter-screen product according to the example (example 1) of the invention and according to two comparative configuration examples (examples 2 and 3). For the comparative examples, the filters both had, as functional element 21 and antireflection coating 11, antireflection films on either side of the substrate, but the stack 20 of Ag layers is, in the case of one of them, deposited directly on the glass (example 2) and in the case of the other one deposited on a plastic film (example 3):
Example 1: adhesive antireflection film 21a/stack of Ag layers/glass/multilayer stack 11;
Example 2: adhesive antireflection film/stack of Ag layers/glass/adhesive antireflection film;

Example 3: adhesive antireflection film/stack of Ag layers on plastic film/glass/adhesive antireflection film.

| | Example 1 | Example 2 | Example 3 |
|---|---|---|---|
| Light reflection, | 3.3 | 5.3 | 2.7 |
| observer's side (%) | | | |
| Optical haze, | 0.3 | 0.6 | 1.3 |
| observer's side | | | |

Example 1 of the invention is clearly the one to adopt, as the multilayer antireflection coating 11 has the advantage of reducing the light reflection on the external face of the window, on the observer's side, while producing a less hazy product after manufacture. The reduction in haze (scattered light) improves the quality of the image and the observer's viewing quality—in particular, the colors are stronger.

According to the invention, the antireflection multilayer stack also constitutes an abrasion-resistant antiscratch coating. Given below is a comparative table and, with regard to FIG. 2, a comparative graph, comparing the example of the invention (example 1) with example 2, relating to the durability test, or accelerated aging test, and to the abrasion test, respectively.

As regards the durability test, the change in light transmission T_{L} and in haze were measured after the window spent 500 hours in dry heat and 120 hours in wet heat.

| | |
|---|---|
| | 90% RH; |
| 500 h at 80° C. | 60° C.; 120 h |

| | ΔT_{L} | Δ haze | ΔT_{L} | Δ haze |
|---|---|---|---|---|
| | (%) | (%) | (%) | (%) |
| Example 1 | <0.2 | <0.2 | <0.3 | <0.2 |
| Example 2 | <0.5 | <0.4 | <1 | <0.2 |

The two products behave identically in the accelerated aging test.

As regards the abrasion test, the change in the haze after abrasion was measured the well-known way using grinding wheels of the Taber Abraser® CS 10 F type with a load of 250 grams on a window of example 1 and on a window of example 2.

The graph in FIG. 2 shows that the window of the invention exhibits much better abrasion behavior in the Taber test than the window of the prior art. After 500 revolutions, the coating with the multilayer stack is hardly scratched, whereas the coating with the plastic film is completely torn, resulting in a complete loss of antireflection properties and causing substantial haze. The micrographs in FIG. 3, with a magnification of 80 times, show the appearance of the two products after the test; the window with the multilayer stack is much cleaner.

Furthermore, the measurements made regarding the scratch resistance shows that the resistance with a multilayer stack is much greater than that with the film. It is only 2 to 3H in the case of the film, whereas it is more than 3H in the case of the multilayer stack. It will be recalled that H is the classification used in the field of surface coatings and organic substrates; it involves a scratch test using a 2H or 3H pencil lead.

The window combined with a plasma screen was taken as an example, but the invention applies, of course, to any type of substrate that possibly has to have at least one functional element on one face and an abrasion-resistant antiscratch coating on its opposite face, which coating may optionally have the advantage of being antireflecting.

1. A transparent, substrate (10) having at least one functional element (20) on one face and an antireflection coating (11) on the opposite face, said coating being made from a stack of thin dielectric layers having alternating high and low refractive indices, characterized in that the antireflection coating is used as abrasion-resistant antiscratch coating.

2. The transparent substrate as claimed in claim 1, characterized in that the abrasion-resistant antiscratch coating formed by the antireflection coating (11) has a resistance of at least 3H and with an abrasion resistance such that the haze of the substrate that may be caused remains less than 1.5%.

3. The substrate as claimed in claim 1, characterized in that the multilayer antireflection coating is deposited on the substrate before the functional element is deposited.

4. The substrate as claimed in claim 1, characterized in that the multilayer stack is based on Si₃N₄ or SnO₂, and SiO₂.

5. The substrate as claimed in claim 1, characterized in that the stack comprises, in succession:
a high-index first layer (c1) having a refractive index n₁ between 1.8 and 2.2 and a geometrical thickness e₁ between 5 and 50 nm;
a low-index second layer (c2) having a refractive index n₂ between 1.35 and 1.65 and a geometrical thickness e₂ between 5 and 50 nm;
a high-index third layer (c3) having a refractive index n₃ between 1.8 and 2.2 and a geometrical thickness e₃ between 70 and 120 nm; and
a low-index fourth layer (c4) having a refractive index n₄ between 1.35 and 1.65 and a geometrical thickness e₄ of at least 80 nm.

6. The substrate as claimed in claim 5, characterized in that the stack is as follows: Si₃N₄/SiO₂/Si₃N₄/SiO2.

7. The substrate as claimed in claim 1, characterized in that the functional element (20) is a metallic electromagnetic shielding element.

8. The substrate as claimed in claim 7, characterized in that the functional element (20) consists of at least one conducting metal layer.

9. The substrate as claimed in claim 7, characterized in that the functional element (20) consists of a stack of thin layers including at least two silver layers.

10. The substrate as claimed in claim 8, characterized in that the multilayer stack has the following sequence:
Si₃N₄/ZnO/Ag/Ti/Si₃N₄/ZnO/Ag/Ti/ZnO/Si₃N₄.

11. The substrate as claimed in claim 7, characterized in that the functional element (20) consists of a network of wires in the form of a grid.

12. The substrate as claimed in claim 7, characterized in that the functional element (20) consists of the combination of a stack of silver-based thin layers and a network of wires in the form of a grid.

13. The substrate as claimed in claim 7, characterized in that the functional element (20) is deposited directly on the substrate (10).

14. The substrate as claimed in claim 7, characterized in that the functional element (20) is deposited on a plastic film bonded to the substrate (10).

15. The substrate as claimed in claim 7, characterized in that the functional element (20) is laminated between two plastic films, one of which is bonded to the substrate (10) whereas the other is bonded to another substrate (10a).

16. The substrate as claimed in claim 7, characterized in that the functional element (20) is combined with a second functional element (21) made of an antireflection coating.

17. The substrate as claimed in claim 16, characterized in that the second functional element (21) is an antireflection multilayer stack (21b).

18. The substrate as claimed in claim 16, characterized in that the second functional element (21) is an adhesive antireflection film (21a).

19. The substrate as claimed in claim 1, characterized in that the substrate is made of untoughened glass.

20. The application of the substrate as claimed in claim 1, to the manufacture of glazing or of filters for display screens.

21. The application as claimed in claim 20 for plasma screens.
